(19) United States
(12) Patent Application Publication
(10) Pub. No.: US 2003/0007428 A1
(43) Pub. Date: Jan. 9, 2003

(54) Magnetic head for magneto-optical recording and magneto-optical recording apparatus for magnetic field modulation method

(75) Inventor: Kazuyoshi Ishii, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/161,665

(22) Filed: Jun. 5, 2002

(30) Foreign Application Priority Data
Jun. 8, 2001 (JP) 174297/2001(PAT.)

(51) Int. Cl. G11B 11/00

(52) U.S. Cl. 369/13.17

(57) ABSTRACT

The invention provides a magneto-optical recording magnetic head comprising a core including a base member consisting of a magnetic material and a pillar-shaped magnetic pole protruding on said base member, and a coil formed by directly winding a wire having an insulating film on the lateral faces of said magnetic pole, wherein angled corner portions are formed on the lateral faces of the magnetic pole so as not to break the insulating film.

### BACKGROUND OF THE INVENTION

1. Field of the Invention

The present invention relates to a magneto-optical recording apparatus for recording information signal on a magneto-optical recording medium by magnetic field modulation method and a magneto-optical recording magnetic head for use therein.

2. Related Background Art

In the magneto-optical recording apparatus for recording information signal at a high density on a magneto-optical recording medium such as a magneto-optical disk, there is conventionally known an apparatus of magnetic field modulation method. The magneto-optical recording apparatus of this method is provided with an optical head, a magneto-optical recording magnetic head (hereinafter called “magnetic head”), and a spindle motor for driving the magneto-optical recording medium.

The recording of information signal on the magneto-optical recording medium is achieved, while the magneto-optical recording medium is rotated by the spindle motor, by applying a magnetic field modulated by the information signal by the magnetic head perpendicularly to a magnetic recording layer of the magneto-optical recording medium and simultaneously irradiating a portion of the magneto-optical recording medium, where the magnetic field is applied, by the optical head with a laser light converged into a light spot of a diameter of about 1 μM.

The magnetic head used in such magneto-optical recording apparatus is composed of a magnetic head core (hereinafter called “core”) consisting of a magnetic material and a coil formed by winding a wire about a magnetic pole formed on the core.

FIG. 18 is a perspective view of a magnetic head disclosed for example in the Japanese Patent Application Laid-open No. 2001-56902. The magnetic head is composed of a core 5 consisting of a rectangular base B of a magnetic material and provided with a magnetic pole P of a square pillar shape protruding at the center of the base, and a coil 6 formed by winding a wire around the magnetic pole P.

In case of recording information signal on the magneto-optical recording medium, a current is supplied to the coil 6 to generate a magnetic field modulated by the information signal from the end face of the magnetic pole P, and such magnetic field is applied perpendicularly to the magneto-optical recording medium.

In order to increase the recording speed of the information signal in the magneto-optical recording apparatus, it is necessary to proportionally increase the modulation frequency of the magnetic field. For this purpose, the inductance of the magnetic head has to be reduced.

In order to reduce the inductance without sacrificing the generation efficiency of the magnetic field (magnetic field intensity per unit supplied current), it is effective to decrease the area of the magnetic pole P at the end face thereof, and also to reduce the lateral face of the magnetic pole P and the coil 6 thereby reducing the internal diameter of the coil 6.

On the other hand, in winding a wire, the bent portion cannot be made rectangular but becomes an arc shape. Also the radius Rw of the wire has a certain limit, and, for example for a wire of a conductor diameter of 35 μm, the lower limit of the bending radius Rw is about 50 μm.

If the wire is bent with a radius smaller than such lower limit,-there may result a breakage in the insulating film of the wire or the conductor itself by the contact with an angled portion of the magnetic pole P, formed sharply by the mechanical grinding work.

If the wire is directly wound around the magnetic pole P by bending with the lower limit radium Rw, the coil 6 is in contact with the magnetic pole P only at the angled portions thereof as shown in a plan view in FIG. 19, with a gap of about 20 μm between the coil 6 and the lateral face of the magnetic pole P.

In practice, therefore, the magnetic head is conventionally prepared not by directly winding the coil 6 around the magnetic pole 6, but by preparing a coreless coil with an internal size larger than that of the magnetic pole 6 and fitting such coil on the magnetic pole P so as not to contact the magnetic pole P as shown in FIG. 20. Such method allows to avoid the aforementioned breakage of the insulating film or the wire conductor, but, in such case, the gap between the coil 6 and the magnetic pole P becomes even larger, exceeding 50 μm.

In the conventional magnetic head, because of the aforementioned reasons, it is difficult to reduce the gap between the coil 6 and the lateral face of the magnetic pole P and the inductance cannot therefore be made sufficiently low.

As a result, in the magneto-optical recording apparatus utilizing such magnetic head, it has not been possible to increase the modulation frequency of the magnetic field and to increase the recording speed of the information signal.

### SUMMARY OF THE INVENTION

The object of the present invention is to provide a magneto-optical recording magnetic head so constructed as to be capable of increasing the modulation frequency of the magnetic field and to prevent breakage of the insulating film of the wire by the lateral face of the magnetic pole and a magneto-optical recording apparatus utilizing such magnetic head.

According to as aspect of the present invention, there is provided a magneto-optical recording magnetic head comprising:

a core including a base member comprised of a magnetic material and a pillar-shaped magnetic pole protruding on the base member;

a coil formed by directly winding a wire having an insulating film on the lateral face of the magnetic pole; and

an angled corner portion formed on the lateral face of the magnetic pole so as not to break the insulating film.

According to another aspect of the present invention, there is provided a magneto-optical recording apparatus comprising:

an aforementioned magneto-optical recording magnetic head; and

an optical head for irradiating with a converged light beam a portion to which the magnetic field is applied by the aforementioned magneto-optical recording magnetic head.

The details of the present invention will be explained in the following embodiments.

### BRIEF DESCRIPTION OF THE DRAWINGS

FIGS. 1A and 1B are views showing the configuration of a magnetic head 9 shown in FIG. 17;

FIG. 2 is a view showing an end face St of a magnetic pole P of which center is positioned at the original point O (X=0 μm, Y=0 μm) of an X-Y coordinate system and longitudinal and transversal directions thereof respectively along the X- and Y-axes, with the distribution of the probability of presence of a light spot in superposed manner;

FIG. 3 is a plan view showing the configuration of a sample 1 of a magnetic head constituting a first embodiment of the present invention;

FIG. 4 is a plan view showing the configuration of samples 2, 3, 4 of a magnetic head constituting a second embodiment of the present invention;

FIG. 5 is a plan view showing the configuration of a sample 5 of a magnetic head constituting a third embodiment of the present invention;

FIG. 6 is a plan view showing the configuration of a sample 6 of a magnetic head constituting a first comparative example;

FIG. 7 is a plan view showing the configuration of a sample 7 of a magnetic head constituting a second comparative example;

FIGS. 8A, 8B and 8C are views showing a method for producing the magnetic head shown in FIGS. 1A and 1B;

FIGS. 9A and 9B are views showing a method for producing the magnetic head shown in FIG. 4;

FIG. 10 is a view showing an end face of a magnetic pole of the sample 1 constituting the first embodiment of the present invention and the distribution of probability of presence of a light spot, shown in superposed manner on X-Y coordinate;

FIG. 11 is a view showing an end face of a magnetic pole of the sample 2 constituting the second embodiment of the present invention and the distribution of probability of presence of a light spot, shown in superposed manner on X-Y coordinate;

FIG. 12 is a view showing an end face of a magnetic pole of the sample 3 constituting the second embodiment of the present invention and the distribution of probability of presence of a light spot, shown in superposed manner on X-Y coordinate;

FIG. 13 is a view showing an end face of a magnetic pole of the sample 4 constituting the second embodiment of the present invention and the distribution of probability of presence of a light spot, shown in superposed manner on X-Y coordinate;

FIG. 14 is a view showing an end face of a magnetic pole of the sample 5 constituting the third embodiment of the present invention and the distribution of probability of presence of a light spot, shown in superposed manner on X-Y coordinate;

FIG. 15 is a view showing an end face of a magnetic pole of the sample 6 constituting the first comparative example and the distribution of probability of presence of a light spot, shown in superposed manner on X-Y coordinate;

FIG. 16 is a view showing an end face of a magnetic pole of the sample 7 constituting the second comparative example and the distribution of probability of presence of a light spot, shown in superposed manner on X-Y coordinate;

FIG. 17 is a schematic view showing the configuration of a magneto-optical recording apparatus embodying the present invention;

FIG. 18 is a perspective view showing a conventional magnetic head;

FIG. 19 is a view showing the drawback in the conventional technology; and

FIG. 20 is a plan view showing the configuration of a conventional magnetic head.

### DESCRIPTION OF THE PREFERRED EMBODIMENTS

Now the present invention will be clarified in detail by embodiments thereof, with reference to the accompanying drawings.

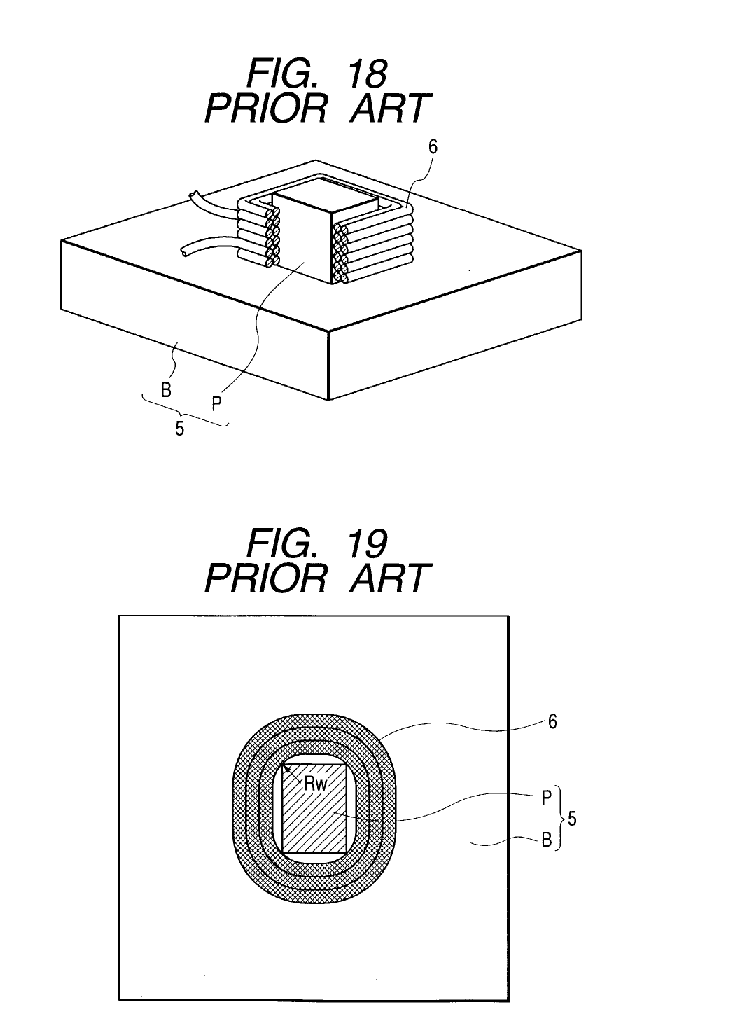

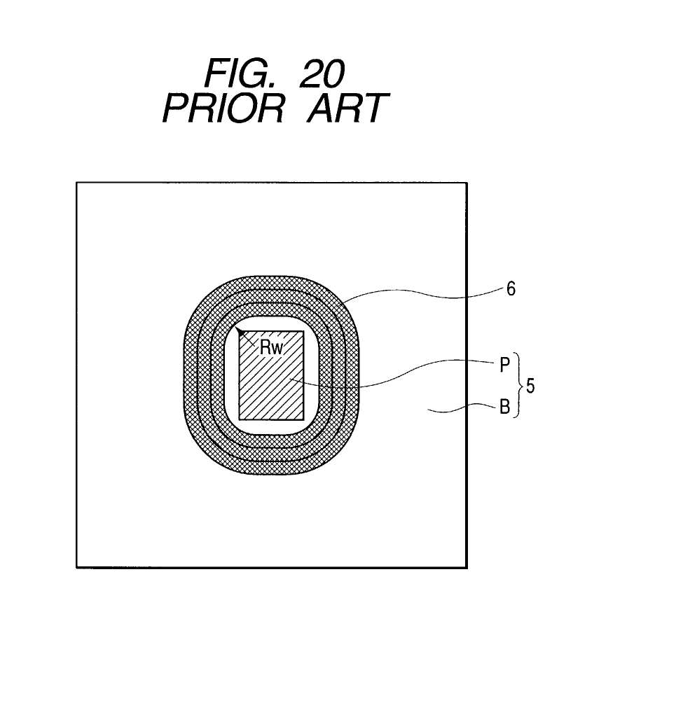

FIG. 17 is a schematic view showing the configuration of a magneto-optical recording apparatus embodying the present invention, wherein shown is a disk 7 constituting a magneto-optical medium on which the information signal is to be recorded and which is provided with a magnetic memory layer of a magnetic material on a substrate of a transparent material.

In the magnetic recording layer, there is formed a concentric or spiral recording track for the information signal. The disk 7 is mounted on a spindle motor 8, and a magnetic head 9 is provided above the disk 7 and an optical head 10 is provided below the disk 7 in opposed relationship to the magnetic head 9.

The magnetic head 9 is composed of a core 1 and a coil 2, which is provided around a magnetic pole P protruding at the center of the core 1. The coil 2 of the magnetic head 9 is connected to a magnetic head driving circuit (not shown).

The magnetic head 9 is mounted on a slider 13 supported by a suspension 12. The bottom face of the slider 13 is so supported as to be pressed to the surface of the disk 7, and the end face of the magnetic pole P is opposed to the upper surface of the disk 7 in this state. The suspension 12 and the optical head 10 are connected by a connecting member 11.

The optical head 10 is composed of a laser light source 14, an objective lens 15 for irradiating the magnetic memory layer of the disk 7 with the laser light, generated by the laser light source 14 and converged into a light spot, and an actuator 16 for driving the objective lens 15 in such a manner that the light spot follows the recording track even when it has a deviation. The laser light source 14 is connected to a laser driving circuit (not shown).

In case of recording the information signal on the disk 7, the disk 7 is rotated by the spindle motor 8, and a current modulated by the information signal to be recorded is supplied from the magnetic head driving circuit to the coil 2, in a state where the slider 13 of the magnetic head 9 slides on the disk 7. Thus a magnetic head modulated by the information signal is generated from the end face of the magnetic pole P of the core 1, opposed to the disk 7, and is perpendicularly applied to the magnetic memory layer of the disk 7 positioned immediately thereunder.

On the other hand, by the current supply from the laser driving circuit, the laser light source 14 emits a laser light which is converged by the objective lens 15 into a light spot of a diameter of about 1 μm and irradiates a portion of the magnetic memory layer immediately under the end face of the magnetic pole P, where the magnetic field is applied.

The actuator 16 executes such tracking control that the light spot following the recording track. In the recording track of the magnetic memory layer, there is formed a magnetized domain of which direction of magnetization varies corresponding to the change in the direction of the applied magnetic field, whereby the information signal is recorded.

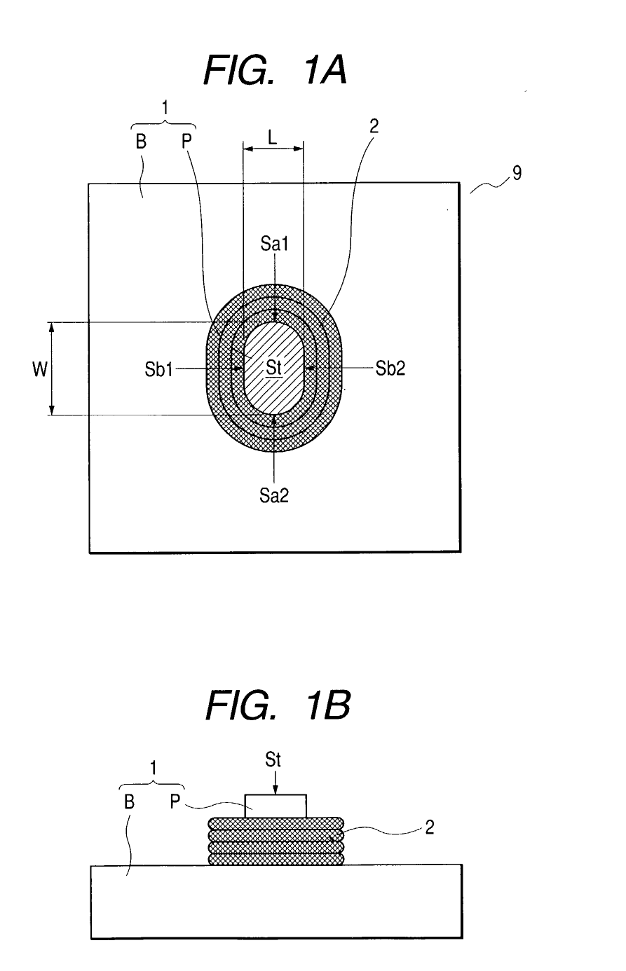

FIGS. 1A and 1B are respectively a plan view and a lateral view showing the configuration of the magnetic head 9 shown in FIG. 17. The magnetic head 9 is composed of a core 1 consisting of a magnetic material such as ferrite and is provided with a rectangular plate-shaped base member B and a pillar-shaped magnetic pole P protruding at the center thereof, and a coil 2 provided around the magnetic pole P.

The coil 2 is formed by directly winding a wire so as to minimize the gap to the lateral faces of the magnetic pole P, and is in contact, at least in a part thereof, with the lateral faces of the magnetic pole P.

The magnetic head 9 is so positioned that the end face St of the magnetic pole P is parallel to the surface of the magneto-optical medium, and it is assumed that the lateral direction in FIGS. 1A and 1B is positioned parallel to the recording track of the magneto-optical medium.

Also the lateral dimension (length of shorter side) or the length L of the end face St is at least equal to 100 μm but does not exceed 250 μm, and the longitudinal dimension (length of longer side) or width W is at least equal to L+40 μm but does not exceed L+200 μm.

The magnetic pole P has a substantially straight shape in the direction of height, so that the shape and dimensions of a cross section parallel to the end face St are substantially same as those of the end face St.

In the illustrated example, the two lateral faces Sa1, Sa2 in the longitudinal direction of the magnetic pole P are formed by semi-circular faces while the two lateral faces Sb1, Sb2 in the lateral direction are formed by flat planes so as not to form angled portions on the lateral faces, but such shape is not restrictive and there may also be adopted a shape not including angled portions smaller than 120° at least on the lateral faces of the magnetic pole P or a shape in which all the angled portions smaller than 120° are removed by beveling or curved surface formation.

Thus, in comparison with the magnetic head having angled portions of 90°, it is rendered possible to reduce the gap between the coil 2 and the lateral faces of the magnetic pole P when the wire is wound by bending with the lower limit of the bending radius.

Also, even if there are formed angled portions, the insulating film of the wire is not damaged upon directly winding the wire so as to be in contact with the lateral faces of the magnetic pole P as long as the angle of such angled portions is at least equal to 120°. It is therefore rendered possible to further reduce the gap between the coil 2 and the lateral faces of the magnetic pole P.

Also, by a change in the shape of the end face St of the magnetic pole P. the area thereof is smaller in comparison with the magnetic pole of rectangular pillar-shape, for a given width W and a given length L of the end face St. In this manner there is reduced the effective area for generating the magnetic field of sufficient intensity, but, despite of such fact, there is not generated any practically unacceptable defect in the recording state of the information signal. Such situation will be explained further in the following.

The intensity of the magnetic field generated by the magnetic head 9 in the perpendicular direction is at least necessary and sufficient for recording the information signal in a position immediately under the end face St of the magnetic pole P, but the intensity rapidly decreases as the magnetic field moves away in the horizontal direction from the position immediately under the end face.

Consequently, in the magneto-optical recording apparatus, if the light spot is formed directly under the end face St of the magnetic pole P, a sufficiently strong magnetic field is applied to the recording portion of the magneto-optical medium to ensure recording of the information signal in the satisfactory state, but, if the position of the light spot is displaced from the position directly under the end face St of the magnetic pole P, there may result a defective recording of the information signal by the deficiency of the magnetic field.

Therefore, at the manufacture of the magneto-optical recording apparatus, the magnetic head and the optical head are so assembled and adjusted that the light spot is positioned at the center of the end face St of the magnetic pole P.

However, the actual relative position between the end face St of the magnetic pole P and the light spot involves errors, such as an error resulting in the positional adjustment and an error resulting from the positional aberration in the magnetic head and the optical head, generated by the environmental change at use such as a temperature change or vibration.

Also, at the recording of the information signal, the light spot is displaced in a direction perpendicular to the recording track of the magneto-optical medium following the deviation thereof by the tracking control, while the magnetic head does not execute such operation following the deviation, so that a variation is generated also in the relative position of the end face St of the magnetic pole P and the light spot. Therefore, the position of the light spot relative to the end face St of the magnetic pole P varies even in the course of recording of the information signal.

Therefore, in order to prevent defective recording state resulting from the displacement of the light spot from the position directly under the end face St of the magnetic pole P even in the presence of an error or a variation in the relative position between the end face St of the magnetic pole P and the light spot, the dimension of the end face St of the magnetic pole P should be designed as large as possible.

If the dimension of the end face St of the magnetic pole P is sufficiently larger than the anticipated range of error or variation in the relative position of the light spot, the light spot is scarcely displaced from directly under the end face St of the magnetic pole P whereby a sufficiently large magnetic field is constantly applied to the recording portion of the magneto-optical medium and there is not generated defective recording of the information signal.

On the other hand, an increase in the area of the end face St of the magnetic pole P increases the inductance of the magnetic head, thus reducing the generating efficiency of the magnetic field and undesirable in improving the recording speed for the information signal or reducing the electric power consumption in the magneto-optical recording apparatus.

However, most magneto-optical recording apparatus are provided with a function of correcting the errors, even in case the recording of the information signal involves certain errors which lead to errors in the reproduced information signal, as long as such errors do not exceed a certain proportion (for example a bit error rate of 10⁻⁴).

Therefore, an incomplete recording state may not necessarily constitute a practical problem if the error rate does not exceed a permissible limit.

Also since the aforementioned error or variation in the position of the light spot relative to the end face St of the magnetic pole P occurs in probable manner, the probability of presence (probable density) of the light spot constitutes a certain distribution in a plane including the end face St of the magnetic pole P. In practice, the error or variation often follows a normal distribution independent for each cause.

Also the amount of positional variation of the light spot, resulting from the tracking control of the optical head, is determined by the magnitude of the deviation in eccentricity of the magneto-optical medium, and is within a range from ±20 μm 100 μm. Such variation occurs only in a direction perpendicular to the recording track, but most of other causes, such as the error in the assembly, occur omnidirectionally, namely with a same probability in any direction.

Therefore, the probability of presence of the light spot, including all these causes, has a distribution wider by 20 μm 100 μm in the direction perpendicular to the recording track than in the direction parallel to the recording track.

Therefore, in consideration of these factors, there has been executed an investigation on the shape and size of the end face St of the magnetic pole P.

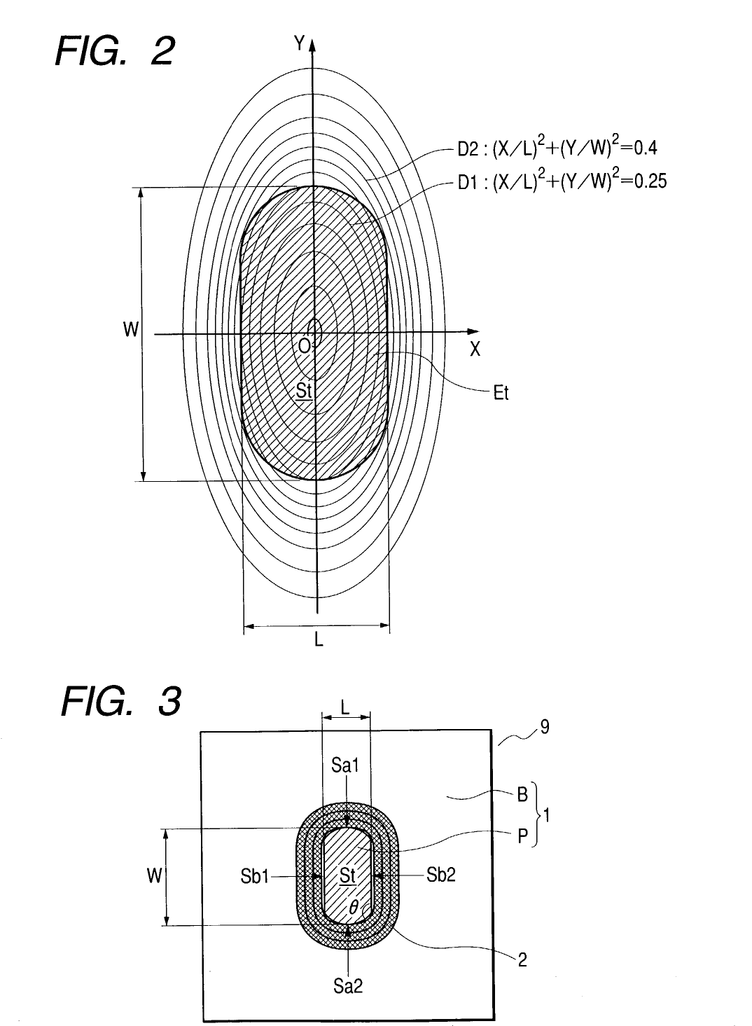

FIG. 2 is a view showing the end face St of the magnetic pole P and the distribution of the probability of presence of the light spot in superposed manner on the X-Y coordinate system, with the center of the end face St on the original point (X=0 μm, Y=0 μm) and the longitudinal and transversal directions thereof respectively along the X- and Y-directions.

As shown in FIG. 2, the probability of presence of the light spot shows a distribution of concentric ovals extended in the Y (vertical) direction, namely in the direction perpendicular to the recording track. On each oval curve, the light spot has a constant probability of presence, and the probability of presence is highest at the original point 0 (center of the end face St of the magnetic pole P) and becomes lower as the distance from the original point increases.

In this figure, D1 indicates the distribution of the probability of presence of the light spot corresponding to the aforementioned permissible limit or the proportion of the defective recording. Therefore, the probability that the light spot is positioned outside the distribution D1 at any timing in the recording of the information signal corresponds to the upper limit of the correctable error rate in the information signal (for example a bit error rate of 10⁻⁴).

If the end face St of the magnetic pole has a size at least containing the distribution D1, the probability that the light spot is positioned outside the end face St is smaller than the aforementioned probability, so that the proportion of the information signal showing defective recording by the displacement of the light spot from directly under the end face St becomes smaller than the aforementioned permissible limit.

The investigation of the distribution of error and variation in the position of the light spot for respective causes has revealed that the distribution D1, though dependent on the method of manufacture, assembly and adjustment of the apparatus, condition of use and error correcting ability in the reproduction of the information signal, has a size within a range of 100 to 250 μm in the lateral direction or in the direction parallel to the recording track and a size in the vertical direction or in the direction perpendicular to the recording track larger by 40 to 200 μm than the size in the lateral direction because of the aforementioned influence of the variation of the light spot in the tracking control.

Also, since most of the error and variations in the position of the light spot show a normal distribution, the curve indicating positions where the probability of presence is same substantially becomes an oval, and for example the distribution D1 substantially coincides with an oval represented by (X/L)²+(Y/W)²=0.25

On the other hand, it is undesirable to unnecessarily increase the size of the end face St of the magnetic pole P because, as explained in the foregoing, an increase in the size of the end face St of the magnetic pole P increases the inductance of the magnetic head thereby lowering the generation efficiency of the magnetic field.

Therefore, in order to minimize the area of the end face St of the magnetic pole P, it is most desirable to match the contour Et thereof with the distribution D1. However the end face St may not be formed in an arbitrary shape for example because of the manufacturing technology.

However it is still desirable to match at least the width W and length L of the end face St of the magnetic pole P respectively with the vertical and lateral sizes of the distribution D1. It is also desirable to drop portions distant from the center O and having a small probability of presence of the light spot, namely angled corner portions of the magnetic pole of the conventional rectangular shape, thereby bringing the end face St close to the distribution D1 or oval shape.

Investigation based on such standpoint has revealed that it is effective to limit the end face St of the magnetic pole P so as not to trespass a distribution D2 showing a probability of presence somewhat lower than the distribution D1, wherein the distribution D2 substantially coincides with an oval represented by (X/L)²+(Y/W)²=0.4.

Thus, by matching the length L and width W of the end face St of the magnetic pole P with the vertical and lateral dimensions of the distribution D1 of the probability of presence of the light spot corresponding to the permissible limit of the recording error rate and by limiting the entire contour Et of the end face within an area represented by 0.25≦(X/L)²+(Y/W)²≦0.4, the error rate in recording is maintained sufficiently low while the inductance is lowered by the decrease in the area of the end face St whereby provided is a magnetic head with an improved generation efficiency of the magnetic field.

In addition to the aforementioned reduction in the area of the end face St of the magnetic pole P, the lateral faces of the magnetic pole P are formed into the aforementioned shape which does not include an angled portion smaller than 120° or in which an angled portion smaller than 120° is omitted by beveling or by curved surface formation, whereby the insulating film of the wire is not damaged by the contact with the angled portion even if the wire is directly wound around the magnetic pole.

In such case, the damage in the insulating film can be completely prevented by forming a beveling of 15 μm or a curved surface of a radius at least equal to 15 μm. In this manner the gap between the coil 2 and the lateral faces of the magnetic pole P can be made smaller to further enhance the aforementioned effects.

FIGS. 1A and 1B etc. illustrate cores in which the angled corner portion is formed into a curved surface, but there may be adopted a pentagonal shape or a polygonal shape of a larger number of corners in such a manner that the angle of the angled portion becomes larger than 120°.

In the following there will be explained embodiments of the present invention, with reference to the accompanying drawings.

[First Embodiment]

FIG. 3 is a plan view showing the configuration of a sample 1 of the magnetic head constituting a first embodiment of the present invention. The end face St of the magnetic pole P has a length L of 150 μm and a width W of 300 μm, and, among the lateral faces of the magnetic pole P, two lateral faces Sa1, Sa2 opposed in the transversal direction are formed with curved surfaces (cylindrical surfaces) while two lateral faces Sb1, Sb2 opposed in the longitudinal direction are formed with flat surfaces.

At the boundaries of the lateral faces Sa1, Sa2 and those Sb1, Sb2 there are formed angled portions with an angle θ of 136°. Such magnetic head is represented as sample 1.

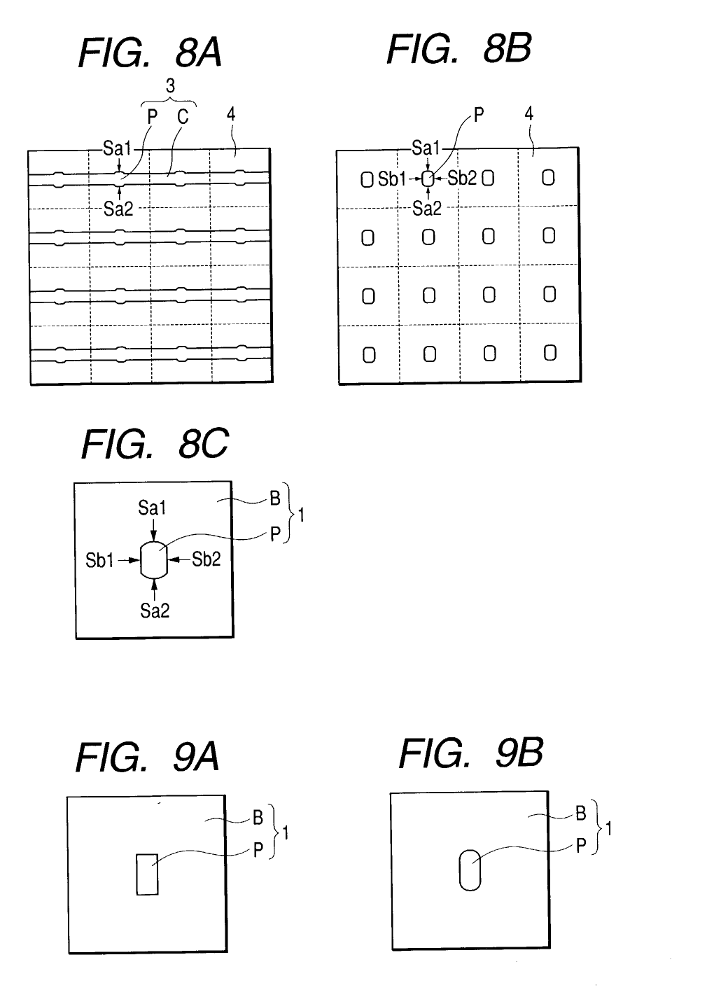

FIGS. 8A to 8C show a method for producing the magnetic head shown in FIGS. 1A and 1B. At first, for forming a core, powder of a magnetic material such as Ni—Zn ferrite or Mn—Zn ferrite is filled into a metal mold and is pressed molded to obtain a molded article shown in FIG. 8A.

The molded article is composed of a flat plate-shaped base member portion 4 and a protruding portion 3 formed thereon. The protruding portion 3 is composed of a plurality of magnetic poles P and a wall-shaped connection portion C which connects the magnetic poles in the lateral direction. In parts of the protruding portion 3, there are formed curved (cylindrical) surfaces which constitute the two lateral faces Sa1, Sa2 opposed in the vertical direction in the magnetic pole P. The lateral faces Sb1, Sb2 of the magnetic pole P in the lateral direction are not yet formed in this stage, since the magnetic poles P are connected in the lateral direction.

By so forming the protruding portion 3 as to include the magnetic pole P but larger than the dimension of the magnetic pole P, namely width W×length L, at least in a direction, the raw material powder can be more easily filled into the metal mold and the strength of the protruding portion 3 becomes larger so that the molded article is not broken at the release from the metal mold.

Then a mechanical grinding work is executed to remove the wall-shaped connection portion C only, leaving the curved faces constituting the lateral faces Sa1, Sa2 of the magnetic pole P, as shown in FIG. 8B. In this manner the two lateral faces Sb1, Sb2 opposed in the lateral direction of the magnetic pole P are formed with flat surfaces, whereby the plural magnetic poles P of the dimension and shape shown in FIG. 3 are formed in respectively isolated state on the base member portion 4.

Then, by cutting the base member portion 4 in broken-lined positions to divide it into plural cores 1 each having a magnetic pole P protruding at the center of a base member B as shown in FIG. 8C. Then a wire is directly wound around the magnetic pole P to form a coil 2, thereby obtaining the magnetic head shown in FIG. 3. In this sample, the gap between the coil 2 and the lateral wall of the magnetic pole P was about 10 μm.

[Second Embodiment]

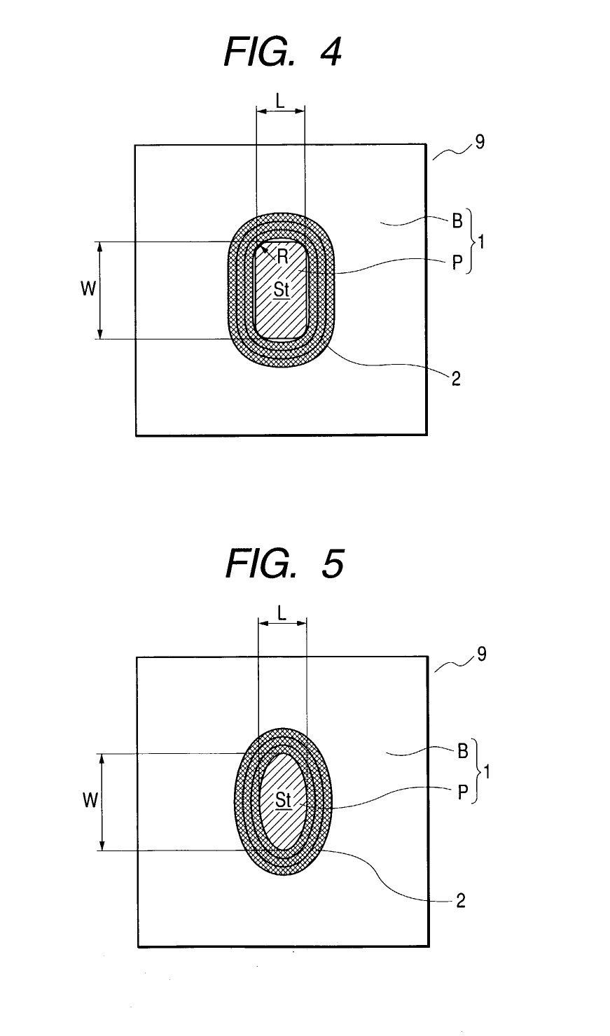

FIG. 4 is a plan view showing the configuration of samples 2, 3, 4 of the magnetic head constituting a second embodiment of the present invention wherein the magnetic pole P has a rectangular pillar shape, of which the end face St has a length L of 150 μm and a width W of 300 μm. However the lateral faces of the magnetic pole P are subjected to rounding to eliminate the angled portions.

The radius R of such curved surface in the samples 2, 3 and 4 is selected respectively as 75, 59 and 41 μm.

FIGS. 9A and 9B are views showing a method for producing the magnetic head shown in FIG. 4. At first a block of a magnetic material such as Ni—Zn ferrite or Mn—Zn ferrite is prepared and mechanically worked to form a core 1 of a shape as shown in FIG. 9A. Since such mechanical working is executed by grinding with a linear movement of a grindstone, angled portions are formed on the lateral faces of the magnetic pole P after the working.

Then polishing is executed for example with a polishing tape bearing diamond particles on the surface to eliminate the angled portions and to obtain desired curved shapes as shown in FIG. 9B. Then a wire is directly wound around the magnetic pole P to form a coil 2, thereby obtaining the magnetic head shown in FIG. 4.

In this sample, the gap between the coil 2 and the lateral wall of the magnetic pole P was 0 to 10 μm. Instead of the curved surface formation as explained in the foregoing, the angled portions of the magnetic pole P may be eliminated by beveling.

[Third Embodiment]

FIG. 5 is a plan view showing the configuration of a sample 5 of the magnetic head constituting a third embodiment of the present invention, wherein the magnetic pole P has an oval shape of which the end face St has a length L of 150 μm and a width W of 300 μm.

The sample 5 of this magnetic head is prepared by at first forming a core 1 with the magnetic pole P of rectangular pillar shape by mechanical working as in the second embodiment, then eliminating the angled portions of the magnetic pole P by polishing to obtain an oval shape and directly winding a wire around the magnetic pole P thereby forming a coil 2 in close contact with the lateral face of the magnetic pole P.

In the following there will be explained first and second comparative examples for comparison with the foregoing embodiments.

[First Comparative Example]

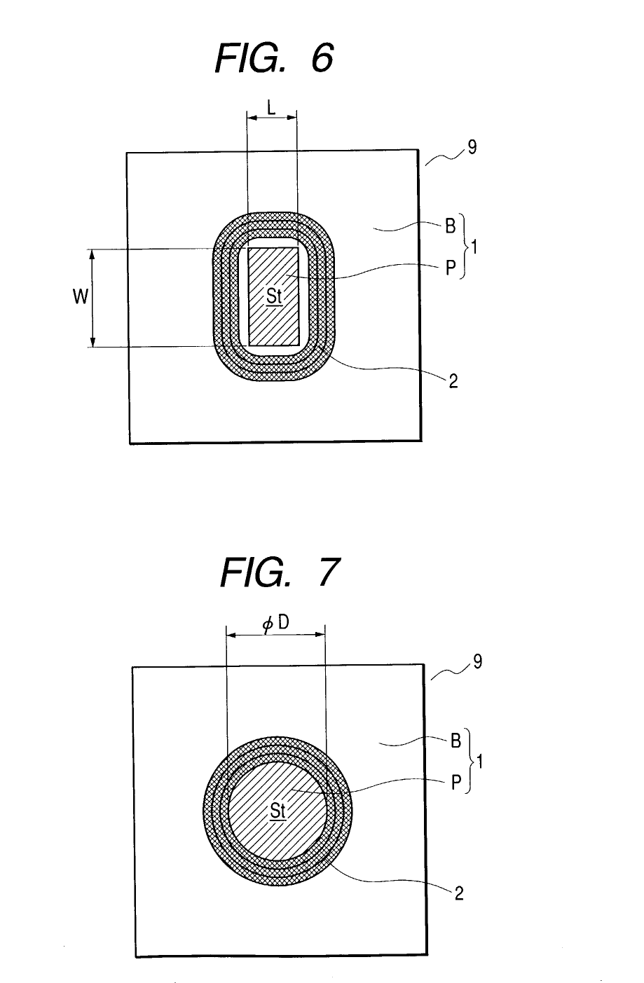

FIG. 6 is a plan view showing the configuration of a sample 6 of the magnetic head of a first comparative example, which is a representative example of the magnetic head provided with the conventional magnetic pole with the angled portions. The magnetic pole P in this example has a rectangular pillar shape of which the end face St has a length L of 150 μm and a width W of 300 μm.

The sample 6 of the magnetic head is prepared by at first preparing a core 1 by mechanical working of a block of a magnetic material such as Ni—Zn ferrite or Mn—zn ferrite, and then by fitting a separately prepared coreless coil 2 so as not to contact the lateral faces of the magnetic pole P with a gap therebetween.

Since such mechanical working is executed by grinding with a linear movement of a grindstone, angled portions are formed on the lateral faces of the magnetic pole P after the working, and the magnetic pole P is used without eliminating such angled portions. In this sample, the gap between the coil 2 and the lateral faces of the magnetic pole P was about 50 μm.

[Second Comparative Example]

FIG. 7 is a plan view showing the configuration of a sample 7 of the magnetic head constituting a second comparative example, in which the magnetic pole P is formed in a simple cylindrical shape without considering the distribution of the probability of presence of the light spot. The end face St of the magnetic pole P has a diameter D of 300 μm.

The sample 7 of the magnetic head is prepared by at first preparing a core 1 by filling powder of a magnetic material such as Ni—Zn ferrite or Mn—zn ferrite into a metal mold and executing press molding, and then by directly winding a wire around the magnetic pole P to form a coil 2 in close contact with the lateral face of the magnetic pole P.

The above-mentioned dimensions are the limit obtainable with this method. For smaller dimensions of the magnetic pole P, the core could not be prepared because it was difficult to introduce the raw material powder into the metal mold and the magnetic pole tended to break at the release from the metal mold.

In all the samples of the foregoing embodiments and comparative examples, the coil 2 was formed with 24 turns.

In the following there will be explained the relationship between the dimension of the end face St of the magnetic pole P and the distribution of the probability of presence of the light spot in each sample of the magnetic head.

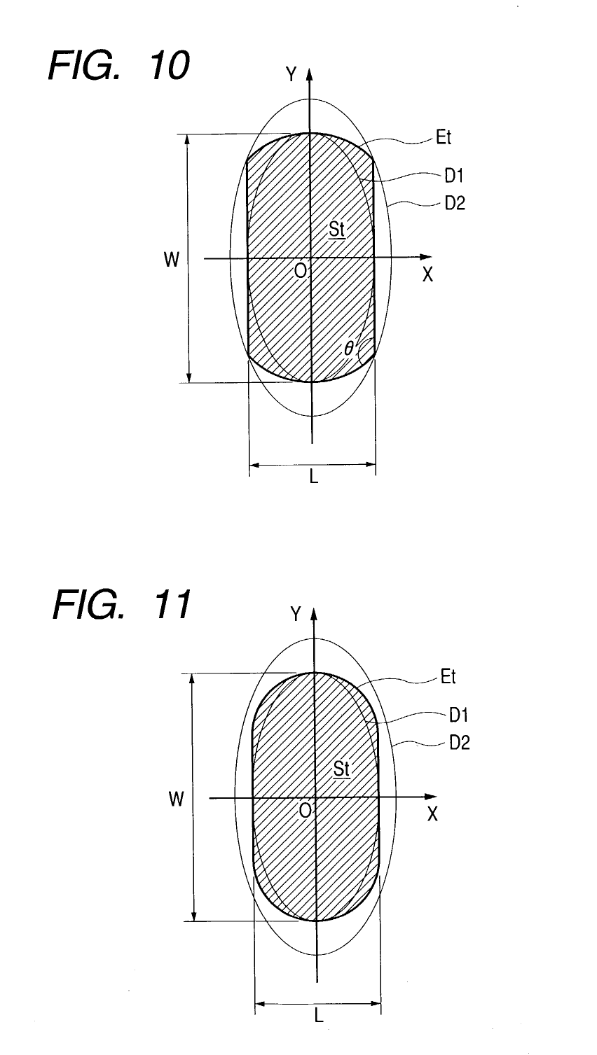

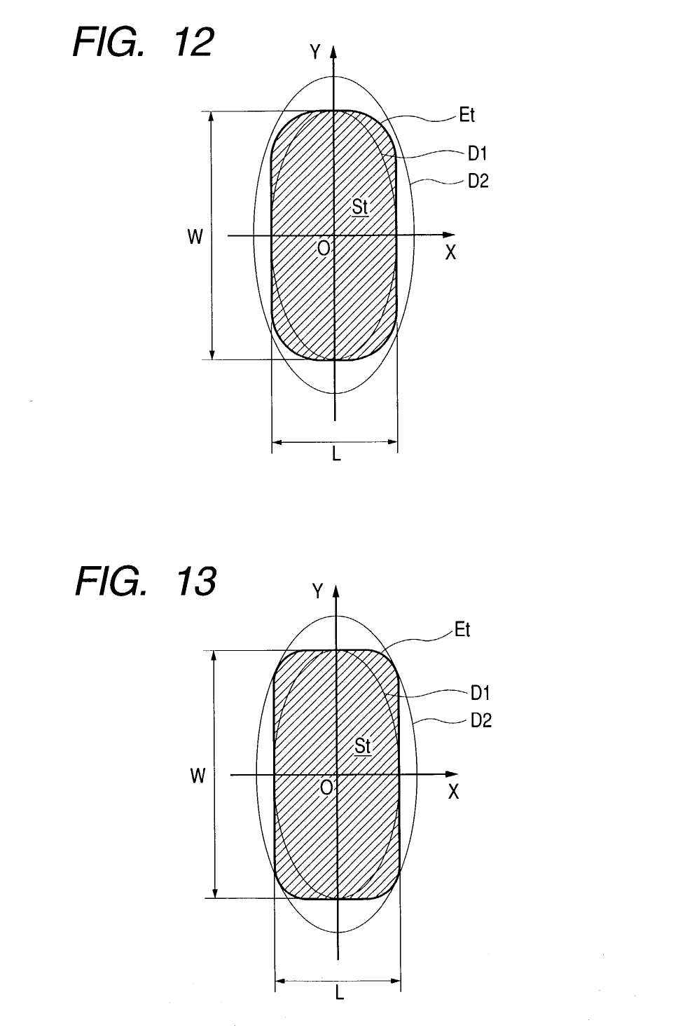

FIGS. 10 to 14 respectively show the end face St of the magnetic pole P of the samples 1 to 5 of the foregoing embodiments and the distribution of the probability of presence of the light spot in superposed manner on the X-Y coordinate system.

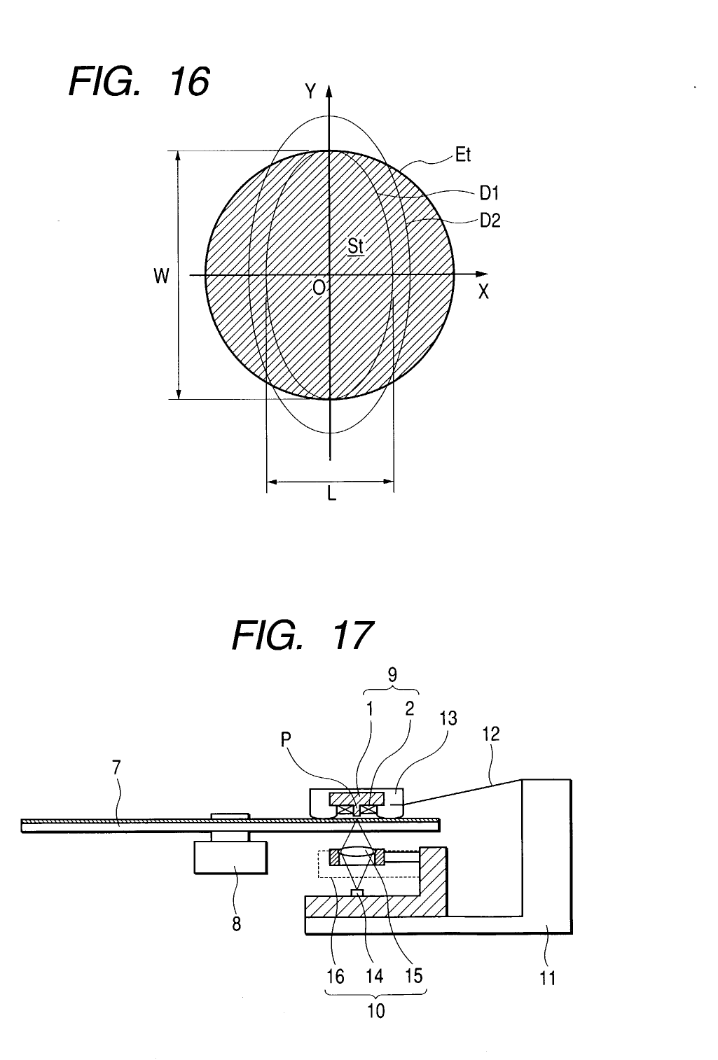

FIGS. 15 and 16 respectively show the end face St of the magnetic pole P of the samples 6 and 7 of the foregoing comparative examples and the distribution of the probability of presence of the light spot in superposed manner on the X-Y coordinate system.

In the preparation of the samples of the foregoing embodiments and comparative examples, based on an investigation on a magneto-optical recording apparatus, the dimension of the distribution of the probability of presence of the light spot corresponding to the permissible limit of the defective recording rate was 300 μm in the vertical direction and 150 μm in the lateral direction, and the length L and width W of the end face St of the magnetic pole P of each sample were so selected as to match such dimension and the end face St of the magnetic pole P was so formed as to include the distribution D1.

However, in the sample 7, the displacement of the light spot by tracking control is not considered, and the diameter D of the end face St is simply selected same as the width W in other samples. Consequently, in all the samples of the foregoing embodiments and comparative examples, the rate of defective recording resulting from the displacement of the light spot from directly under the end face St of the magnetic pole P is smaller than the permissible limit corresponding to the error correction limit and does not therefore constitute a practical problem.

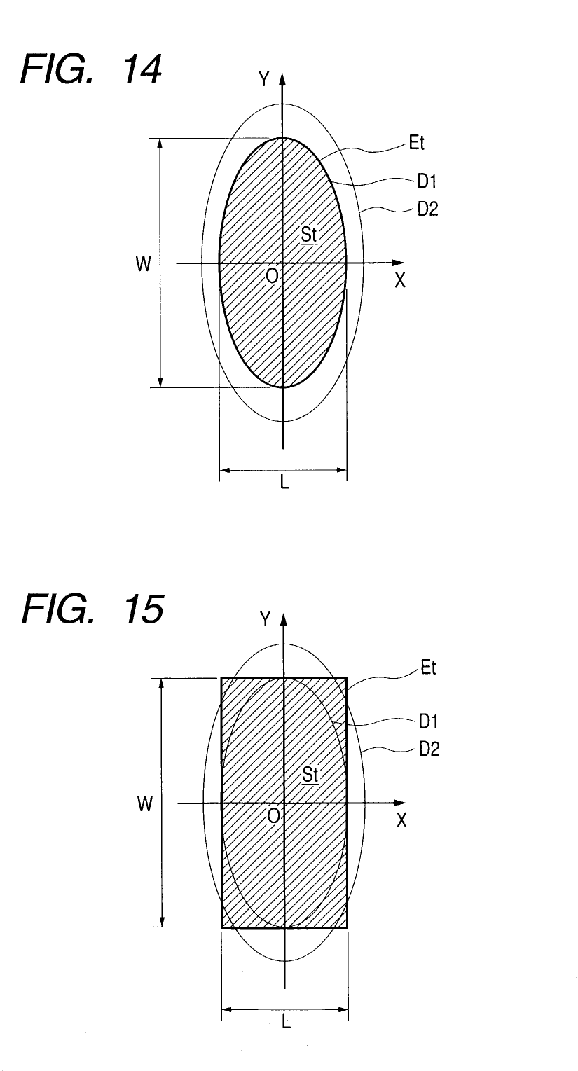

Also in the samples 1 to 5, the area of the end face St is reduced by limiting the end face St within the distribution D2. More specifically, in the samples 1 and 4, the contour Et of the end face St of the magnetic pole is contact in a part thereof with the distribution D2 as shown in FIGS. 10 and 13, and the end face St of the sample 4 has the largest area among the samples. Also in the sample 5, the contour Et of the end face St coincides with the distribution D1 as shown in FIG. 14 and has therefore the smallest area among the samples.

Consequently, in the samples 1 to 5 embodying the present invention, the entire contour Et of the end face St of the magnetic pole is shaped between the distributions D1 and D2, namely so as to be in an area represented by 0.25≦(X/L)²+(Y/W)²≦0.4, while, in the samples 6 and 7 of the comparative examples, the contour Et of the end face of the magnetic pole P is at least partly positioned outside the distribution D2.

Therefore, the area of the end face St of the magnetic pole is smaller in the samples 1 to 5 embodying the present invention than in the comparative examples 6 and 7.

Following table 1 shows the results of measurement of the inductance and the magnetic field generating efficiency in the foregoing samples of the magnetic head. The generating efficiency of the magnetic field is represented by the intensity of magnetic field generated per supplied current of 1 mA, in a position of 20 μm above the center of the end face St of the magnetic pole P.

TABLE 1

| | Inductance | Magnetic field generating |
|---|---|---|
| Sample No. | (μH) | efficiency (Oe/mA) |
| 1st embodiment | | |
| 1 | 0.87 | 1.63 |
| 2nd embodiment | | |
| 2 | 0.87 | 1.62 |
| 3 | 0.88 | 1.62 |
| 4 | 0.92 | 1.58 |
| 3rd embodiment | | |
| 5 | 0.84 | 1.68 |
| 1st comp. ex. | | |
| 6 | 0.98 | 1.40 |
| 2nd comp. ex. | | |
| 7 | 1.30 | 1.15 |

As will be apparent from Table 1, the samples 1 to 5 of the magnetic head in which the shape and size of which the end face St of the magnetic pole is limited by the distribution D2 of the probability of presence of the light spot show reduced gap between the coil 2 and the lateral face of the magnetic pole, in addition to the reduced area of the end face St, thereby showing a lower inductance and a higher efficiency of magnetic field generation, in comparison with the samples 6 and 7 of the comparative examples.

In particular, the sample 5, having the smallest area of the end face St of the magnetic pole, shows an inductance lower by 14.3% and a magnetic field generating efficiency higher by 20% in comparison with the sample 6 of the comparative example. Also, even the sample 4 having the largest area of the end face St of the magnetic pole shows an inductance lower by 6.1% and a magnetic field generating efficiency higher by 12.9% in comparison with the sample 6 of the comparative example.

In the foregoing embodiments, the number of turns of the coil is maintained constant in making comparison with the comparative examples, whereby simultaneously achieved are the reduction in inductance and the improvement in the magnetic field generating efficiency, but, by adjusting (increasing) the number of turns of the coil so as to bring the inductance comparable to that of the comparative examples, the magnetic field generating efficiency can be made even larger.

Also by adjusting (decreasing) the number of turns of the coil so as to bring the magnetic field generating efficiency comparable to that of the comparative examples, the inductance can be made even smaller.

What is claimed is:

1. A magneto-optical recording magnetic head comprising:
a core including a base member comprised of a magnetic material and a pillar-shaped magnetic pole protruding on said base member;
a coil formed by directly winding a wire having an insulating film on the lateral faces of said magnetic pole; and
an angled corner portion formed on the lateral face of said magnetic pole so as not to break said insulating film.

2. A magnetic head according to claim 1, wherein the cross section in planar direction of said magnetic pole is a rectangular shape rounded on both ends or a polygonal shape having at least five angled portions and the angle of each of said angled portions is larger than 120°.

3. A magnetic head according to claim 1, wherein the cross section in planar direction of said magnetic pole has a length L in the shorter direction in a range of from 100 to 250 μm and a length W in the longitudinal direction in a range of from L+40 to L+200 μm wherein L is the length in the shorter direction.

4. A magnetic head according to claim 1, wherein said angle portion is formed by beveling of 15 μm or larger, or by a curved surface formation of a radius of 15 μm or larger.

5. A magnetic head according to claim 3, wherein the contour of the cross section in planar direction of said magnetic pole is so formed as to satisfy a relation 0.25≦(X/L)²+(Y/W)²≦0.4 wherein the center of the cross section is placed at the original point and said shorter and longitudinal directions are respectively directed in the X and Y axes.

6. A magneto-optical recording apparatus comprising:
a magneto-optical recording magnetic head according to claim 1; and
an optical head for irradiating with a converged light beam a portion to which the magnetic field is applied by said magneto-optical recording magnetic head.
